(19) United States
(12) Patent Application Publication
(10) Pub. No.: US 2023/0108662 A1
(43) Pub. Date: Apr. 6, 2023

(54) ELECTROSTATIC CHARGE IMAGE DEVELOPING TONER AND PRODUCTION METHOD OF ELECTROSTATIC CHARGE IMAGE DEVELOPING TONER

(71) Applicant: Konica Minolta, Inc., Tokyo (JP)

(72) Inventor: Kazuya ISOBE, Tokyo (JP)

(21) Appl. No.: 17/932,119

(22) Filed: Sep. 14, 2022

(30) Foreign Application Priority Data
Oct. 5, 2021 (JP) 2021-163839

(51) Int. Cl. G03G 9/087

(52) U.S. Cl. CPC G03G 9/0874

(57) ABSTRACT

Provided is an electrostatic charge image developing toner including toner matrix particles containing a binder resin and a colorant, wherein the toner matrix particles contain, as the binder resin, at least a polymer having a first structural unit represented by the following Formula (1),

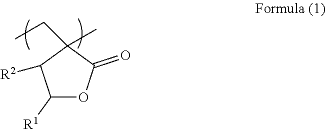

in Formula (1), R₁ and R₂ each independently represent a hydrogen atom or an alkyl group having 1 to 4 carbon atoms.

### CROSS-REFERENCE TO RELATED APPLICATIONS

The entire disclosure of Japanese Patent Application No. 2021-163839 filed on Oct. 5, 2021 is incorporated herein by reference in its entirety.

### BACKGROUND

### Technological Field

The present invention relates to an electrostatic charge image developing toner and a method for producing an electrostatic charge image developing toner. In particular, the present invention relates to an electrostatic charge image developing toner which is excellent in bending resistance of printed matter while satisfying low temperature fixability, and a method for producing the same.

### Description of the Related Art

In the field of printing where images are formed by an electrophotographic method, in recent years, there has been a demand for an electrostatic charge image developing toner (hereinafter simply referred to as a “toner”) that is capable of responding to reduced power consumption, faster printing, diversification of image forming media, higher image quality, and reduced environmental impact.

Among the characteristics required for such toners are so-called low temperature fixability, which means that toner images may be fixed at a lower temperature than before, and improved fixation strength. Furthermore, as the market expands beyond the conventional office market to the light printing market, there is a demand for improved stability in the image quality of printed materials, which are the commercial products.

Toners usually contain a binder resin having a binder function (hereinafter also referred to as a “toner binder”). As the binder resin, it is known to use a styrene-acrylic resin, a polyester resin, and a hybrid resin such as a polyester resin having a grafted acrylic polymer segment. In response to the above requirements, there are known techniques for improving low temperature fixability by improving these toner binders. See, for example, Patent Documents 1 to 3.

Patent Document 1: JP-A 2007-279714

Patent Document 2: JP-A 2008-287229

Patent Document 3: JP-A 2010-15159

In addition, not only in the light printing market but also in other markets, toner particle size reduction is required in order to achieve high image quality in printed matter, and the production method of the toner is shifting from the conventional pulverization method to the chemical method. By reducing the particle size of toner, the toner may adhere more homogeneously to the electrostatic latent image, and thus, higher image quality may be achieved.

Thus, by adopting a binder resin that may be fixed at lower temperatures, and by reducing the diameter of toner particles, it has been possible to reduce power consumption, increase printing speed, improve image quality, and reduce environmental impact.

On the other hand, the light printing market is being actively developed, and there are increasing demands to prevent toner peeling (spine cracking) caused by folding and bending, which is likely to be a problem when printing small-lot booklets. In order to improve the folding and bending resistance, post-processing, such as lamination using polypropylene (PP) film, has been used to improve the folding and bending resistance.

### SUMMARY

The present invention was made in view of the above-mentioned problems and circumstances, and an object of the present invention is to provide an electrostatic charge image developing toner which has excellent bending resistance of printed matter while satisfying low temperature fixability, and a method for producing the same.

In the course of examining the cause of the above problem in order to solve the above problem, the inventor found that by including a polymer having a specific structural unit as a binder resin, it is possible to provide an electrostatic charge image developing toner having excellent bending resistance of printed matter while satisfying low temperature fixability. Thus, the present invention has been achieved. That is, the above problem according to the present invention is solved by the following means.

To achieve at least one of the above-mentioned objects of the present invention, an electrostatic charge image developing toner that reflects an aspect of the present invention is as follows.

An electrostatic charge image developing toner comprising toner matrix particles containing a binder resin and a colorant, wherein the toner matrix particles contain, as the binder resin, at least a polymer having a first structural unit represented by the following Formula (1),

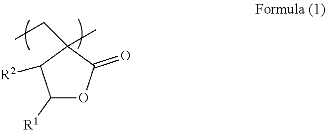

in Formula (1), R₁ and R₂ each independently represent a hydrogen atom or an alkyl group having 1 to 4 carbon atoms.

Another aspect of the present invention is the following method for producing an electrostatic charge image developing toner.

A method for producing an electrostatic charge image developing toner comprising toner matrix particles containing a binder resin and a colorant, the method comprising a step of preparing a resin particle dispersion liquid containing a polymer obtained by copolymerizing at least a first polymerizable monomer having a structure represented by the following Formula (2),

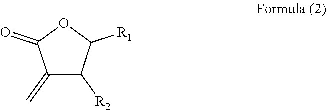

in Formula (2), R₁ and R2 each independently represent a hydrogen atom or an alkyl group having 1 to 4 carbon atoms.

By the above means, it is possible to provide an electrostatic charge image developing toner which has excellent bending resistance of printed matter while satisfying low temperature fixability, and a method for producing the electrostatic charge image developing toner. Although the expression mechanism or the action mechanism of the effect of the present invention is not clear, it is inferred as follows. The following mechanism is by way of speculation, and the present invention is not limited in any way to the following mechanism. In the following description, the polymer having a first structural unit represented by the above Formula (1) is also referred to as “the polymer according to the present invention”.

Conventional toners containing a styrene-acrylic resin are composed of structural units derived from styrene, methyl methacrylate, and n-butyl acrylate as a main component. In order to reduce the power consumption during printing, the so-called low temperature fixation is being promoted by lowering the Tg (glass transition temperature) and lowering the molecular weight.

On the other hand, low temperature fixing, especially low Tg, tends to cause blocking during toner transportation, so there is a limit to the level that can be lowered. As for low molecular weight, the interaction between polymer chains becomes smaller as the molecular weight becomes lower, so that the polymer cannot withstand stress caused by bending, and rupture occurs, making it difficult to retain an image on a medium. Thus, it is a difficult problem to secure the bending resistance while satisfying the low temperature fixability, and especially in the field of commercial printing, the compatibility of the two is required.

The reason why the toner of the present invention was able to both satisfy low temperature fixability and ensure bending resistance may be considered to be due to a change in the interaction between the polymer chains by introducing a specific structural unit (a first structural unit). By introducing the polymer having the first structural unit represented by the aforementioned Formula (1) according to the present invention into the toner binder, a resin structure is formed in which a bulky substituent is directly bonded to the main chain. Therefore, it is considered that the rigidity of the main chain is increased and the rigid part becomes rigid, and conversely, the degree of freedom of the main chain movement is increased due to the steric hindrance caused by the bulky substituent group. Therefore, it may be inferred that the stress generated by the bending of the printed matter may be converted into thermal energy, and the bending resistance may be improved.

### DETAILED DESCRIPTION OF THE EMBODIMENTS

Hereinafter, one or more embodiments of the present invention will be described. However, the scope of the invention is not limited to the disclosed. However, the scope of the invention is not limited to the disclosed embodiments. The electrostatic charge image developing toner of the present invention is an electrostatic charge image developing toner including toner matrix particles containing a binder resin and a colorant, wherein the toner matrix particles contain, as the binder resin, at least a first structural unit represented by the following Formula (1). This feature is a technical feature common to or corresponding to each of the following embodiments.

As an embodiment of the present invention, it is preferred that R₁ and R₂ in the above Formula (1) each independently represent a hydrogen atom or a methyl group in order to better achieve both low temperature fixability and bending resistance.

It is also preferred that R₁ in Formula (1) represents a methyl group and R₂ in Formula (1) represents a hydrogen atom, in that both low temperature fixability and bending resistance are more compatible.

It is preferred that the toner matrix particles contain, as the binder resin, a copolymer having the first structural unit and other second structural unit, in order to more efficiently demonstrate the effect of the present invention.

It is also preferred that the second structural unit is a structural unit derived from at least one of styrene, acrylic acid, acrylic ester, methacrylic acid or methyl methacrylate. In particular, the second structural unit is preferably at least one of styrene, n-butyl acrylate, 2-ethylhexyl acrylate, methacrylic acid or methyl methacrylate. It facilitates adjustment of the glass transition temperature of the polymer according to the present invention.

It is preferred that the crystalline polyester resin is contained in the range of 5 to 30% by mass in the binder resin. The crystalline polyester resin has a faster melting speed than the styrene-acrylic resin and may improve the fixability of the toner on paper. Therefore, when 5% by mass or more of the crystalline polyester resin is contained, the effect of improving the fixing property is significant, and when 30% by mass or less of the crystalline polyester resin is contained, the charge retention ability of the toner is not reduced and it is possible to use as a toner. Therefore, it is preferable that the binder resin includes the crystalline polyester resin in the range of 5 to 30% by mass from the viewpoint of achieving both fixability and charge retention.

It is preferred that the crystalline polyester resin is a hybrid crystalline polyester resin formed by chemical bonding of a polyester polymer segment and a vinyl polymer segment. The hybrid crystalline polyester resin is preferred in that it is partially compatible with the polymer having the first structural unit represented by the above Formula (1) and is finely dispersed in the toner, thereby obtaining excellent low temperature fixability.

The method for producing an electrostatic charge image developing toner of the present invention is a method for producing an electrostatic charge image developing toner comprising toner matrix particles containing a binder resin and a colorant. The method is characterized in that it has the step of preparing a resin particle dispersion liquid containing a polymer obtained by copolymerizing at least a first polymerizable monomer having a structure represented by Formula (2). Thereby, a toner having good low temperature fixability and excellent bending resistance may be produced.

Hereinafter, the present invention, its constituent elements, and modes and embodiments for carrying out the present invention will be described. In this application, “to” is used in the sense of including the numerical values described before and after “to” as lower and upper limits.

### [Electrostatic Charge Image Developing Toner of the Present Invention]

The electrostatic charge image developing toner (hereinafter simply referred to as a “toner”) of the present invention is an electrostatic charge image developing toner including toner matrix particles containing a binder resin and a mold release agent, wherein the toner matrix particles contain, as the binder resin, at least a polymer having a first structural unit represented by the following Formula (1).

In this specification, “toner matrix particles” constitute the matrix of the “toner particles”. The “toner matrix particles” include at least a binder resin and a mold release agent, and may also include other components such as a colorant and a charge control agent, as necessary. The “toner matrix particles” are referred to as “toner particles” by the addition of the external additive. And the term “toner” refers to an aggregate of “toner particles”.

### <Binder Resin>

The binder resin according to the present invention contains a polymer having a first structural unit represented by the following Formula (1).

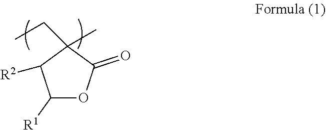

In Formula (1), R₁ and R₂ each independently represent a hydrogen atom or an alkyl group having 1 to 4 carbon atoms.

(Polymer having a First Structural Unit Represented by Formula (1))

R₁ and R₂ in the above Formula (1) each independently represent a hydrogen atom or an alkyl group having 1 to 4 carbon atoms. Specific examples of the alkyl group include a methyl group, an n-butyl group, and an iso-butyl group. From the viewpoint of further improving the low temperature fixability and the folding resistance, it is preferred that R₁ and R₂ each independently represent a hydrogen atom or a methyl group, and it is particularly preferred that R₁ represents a methyl group and R₂ represents a hydrogen atom.

The polymer having a first structural unit represented by the above Formula (1) may be synthesized by polymerizing a monomer having a structure represented by the following Formula (2) (hereinafter also referred to as a “first polymerizable monomer”).

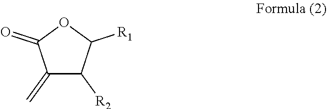

In Formula (2), R₁ and R₂ each independently represent a hydrogen atom or an alkyl group having 1 to 4 carbon atoms. R₁ and R₂ are synonymous with R₁ and R₂ in the above Formula (1). The first polymerizable monomer may be used alone or in combination of two or more kinds.

Specific examples of the first polymerizable monomer include, but are not limited to, the following example compounds M1 to M8.

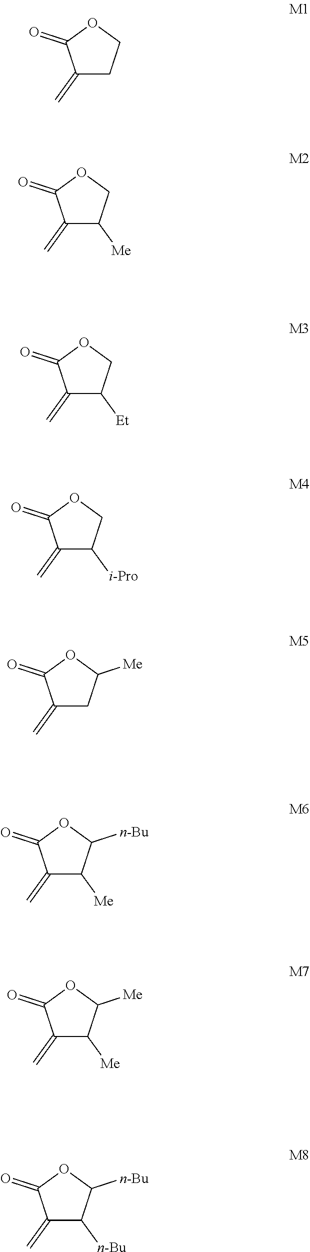

The first polymerizable monomer may be a commercially available product or a synthetic product. The polymerization method of the first polymerizable monomer is not particularly restricted, but from the viewpoint of easy synthesis, the method of radical polymerization of the monomer using a known oil-soluble or water-soluble radical polymerization initiator is preferred.

That is, the method of producing a toner according to one preferred embodiment of the present invention comprises the step of carrying out (radical) polymerization of a first polymerizable monomer having a structure represented by Formula (2) to synthesize a polymer having the first structural unit represented by the above Formula (1) and preparing a resin particle dispersion liquid containing this polymer.

Examples of the oil-soluble polymerization initiator used for radical polymerization include, specifically, azo-based or diazo-based polymerization initiators and peroxide-based polymerization initiators listed below. If necessary, for example, n-octyl mercaptan, n-octyl-3-mercaptopropionate, and other known chain transfer agents may be used as needed.

Examples of the azo-based or diazo-based polymerization initiator include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

Examples of the peroxide-based polymerization initiator include benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,4-dichlorobenzoyl peroxide, lauroyl peroxide, 2,2-bis-(4,4-t-butylperoxycyclohexyl)propane, and tris-(t-butylperoxy)triazine.

In the case of forming a polymer having a first structural unit represented by Formula (1) according to the present invention by emulsion polymerization, a water-soluble radical polymerization initiator may be used.

Examples of the water-soluble radical polymerization initiator include persulfates such as potassium persulfate and ammonium persulfate, azobisaminodipropane acetate, azobiscyanovaleric acid and its salts, and hydrogen peroxide.

Although the polymerization temperature varies depending on the monomer used and the type of polymerization initiator, it is preferred to be in the range of 50 to 100° C., and it is more preferred to be in the range of 55 to 90° C. The polymerization time varies depending on the type of monomer and polymerization initiator used, but for example, 1 to 12 hours is preferred.

(Polymer with Other Structural Unit)

The polymer having the first structural unit represented by Formula (1) according to the present invention may be a polymer obtained only from the polymerizable monomer (first polymerizable monomer) having the structure represented by Formula (2).

However, from the viewpoint of more efficiently demonstrating the effect of the present invention, it may be a copolymer of other polymerizable monomer that may be copolymerized with the first polymerizable monomer (also referred to as a “second polymerizable monomer”) such as described in the following.

Examples of the second polymerizable monomer include styrene-based monomers such as styrene, α-methylstyrene, o-methylstyrene, m-methylstyrene, p-methylstyrene, o-methoxystyrene, p-methoxystyrene, m-methoxystyrene, o-ethylstyrene, m-ethylstyrene, p-ethylstyrene, o-acetoxystyrene, m-acetoxystyrene, and p-acetoxystyrene; acrylic esters such as methyl acrylate, ethyl acrylate, isopropyl acrylate, n-butyl acrylate, tert-butyl acrylate, isobutyl acrylate (iso-butyl acrylate), n-octyl acrylate, 2-ethylhexyl acrylate, stearyl acrylate, lauryl acrylate, and phenyl acrylate; and methacrylic esters such as methyl acrylate, ethyl acrylate, n-butyl acrylate, isopropyl acrylate, isobutyl methacrylate, tert-butyl methacrylate, n-octyl methacrylate, 2-ethylhexyl methacrylate, stearyl methacrylate, lauryl methacrylate, phenyl methacrylate, dimethylaminoethyl methacrylate, and diethylaminoethyl methacrylate.

Among these, at least one selected from styrene or acrylic ester is preferred from the viewpoint that the glass transition temperature of the polymer is easily adjusted, and at least one selected from the group consisting of styrene, n-butyl acrylate, 2-ethylhexyl acrylate, 2-ethylhexyl acrylate, and methyl methacrylate is preferred. At least one of styrene or n-butyl acrylate is more preferred.

Further, a polymerizable monomer having an ionic dissociative group may be used as the second polymerizable monomer. The polymerizable monomer having an ionic dissociative group is, for example, one having a carboxy group, a sulfonic acid group, or a phosphoric acid group. Specific examples include acrylic acid, methacrylic acid, maleic acid, itaconic acid, and fumaric acid. Of these, acrylic acid or methacrylic acid is preferred. These second polymerizable monomers may be used alone or in combination of two or more kinds

In the polymer according to the present invention, the content of the structural unit derived from the first polymerizable monomer is preferably, for example, in the range of 1 to 60% by mass, with the total structural unit of the polymer according to the present invention being 100% by mass, and it is more preferred that the content is in the range of from 20 to 50% by mass. In the polymer according to the present invention, the content of the structural unit derived from the second polymerizable monomer is not particularly limited and may be adjusted according to the type of the structural unit.

For example, when the second polymerizable monomer is a styrene monomer described above, the content of the structural unit derived from the styrene monomer in the polymer according to the present invention is in the range of 10 to 50% by mass, with the total structural unit of the polymer of the present invention being 100. It is more preferred that the content is in the range of 20 to 40% by mass.

When the second polymerizable monomer is an acrylic ester or a methacrylic ester, the content of the structural unit derived from the acrylic ester or the methacrylic ester in the polymer according to the present invention is preferably in the range of 5 to 50% by mass, with the total structural unit of the polymer of the present invention being 100% by mass It is more preferred that the content is in the range of 10 to 40% by mass

When a polymerizable monomer having an ionic dissociative group is used, the content of the structural unit is preferably in the range of 3 to 8% by mass, with the total structural unit of the polymer according to the present invention being 100% by mass.

The method of synthesizing the polymer according to the present invention using the first polymerizable monomer and the second polymerizable monomer is the same as the method of polymerization of the first polymerizable monomer described above, and therefore, the description is omitted here.

The polymer according to the present invention has preferably a peak molecular weight obtained from the molecular weight distribution by polystyrene conversion measured by gel permeation chromatography (GPC) in the range of 3,500 to 35,000, and more preferably in the range of 10,000 to 30,000. When the peak molecular weight is in such a range, the polymer has an appropriate melt viscosity at the time of fixing, and good fixability and offset resistance may be achieved at the same time, which is preferable. A peak molecular weight is a molecular weight corresponding to the elution time of the peak top in the molecular weight distribution. If there are multiple peaks in the molecular weight distribution, it refers to the molecular weight corresponding to the elution time of the peak top with the largest peak area ratio.

The peak molecular weight of the polymer may be measured by the following method. Specifically, the instrument “HLC-8220” (Tosoh Corporation) and the column “TSKguardcolumn and TSKgel SuperHZM-M Triple” (Tosoh Corporation) are used, and the column temperature is kept at 40° C. Tetrahydrofuran (THF) is poured through the column at a flow rate of 0.2 ml/min. The sample is dissolved at room temperature (25° C.) using an ultrasonic dispersion machine for 5 minutes to obtain a concentration of 1 mg/ml. The sample is dissolved in tetrahydrofuran to a concentration of 1 mg/ml.

The sample solution is then processed through a membrane filter with a pore size of 0.2 μm to obtain a sample solution, and 10 μL of this sample solution is injected into the apparatus together with the above-mentioned carrier solvent and detected using a refractive index detector (RI detector), and the molecular weight distribution of the sample is measured from the molecular weight distribution of the sample.

From the viewpoint of a balance of low temperature fixability and bending resistance, it is preferable that the content ratio of the polymer according to the present invention is in the range of 65 to 99% by mass, with the total mass of the binder resin being 100% by mass. It is more preferable that the content is in the range of 70 to 95% by mass.

The binder resin according to the present invention may contain a resin other than the polymer of the present invention, and the resins generally used as a binder resin constituting toners may be used without limitation.

Examples thereof include a polyester resin, a silicone resin, a polyolefin resin, a polyamide resin, and an epoxy resin. These other resins may be used alone or in combination of two or more resins.

Polyester resins that may be used as a binder resin are described below.

### (Polyester Resin)

The polyester resin is a known polyester resin obtained by polycondensation reaction of a divalent or more carboxylic acid (polyvalent carboxylic acid component) and a divalent or more alcohol (polyhydric alcohol component). The polyester resin may be amorphous or crystalline.

The valence number of the polyvalent carboxylic acid component and the polyhydric alcohol component is preferably 2 to 3 respectively, and especially preferably 2 each. Therefore, the case where the valence number is 2 (i.e., the dicarboxylic acid component and the diol component) will be described as a particularly preferred form.

Examples of the dicarboxylic acid component include saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; unsaturated aliphatic dicarboxylic acids such as methylene succinic acid, fumaric acid, maleic acid 3-hexenedioic acid, 3-octenedioic acid, and dodecenyl succinic acid; and unsaturated aromatic dicarboxylic acids such as phthalic acid, terephthalic acid, isophthalic acid, t-butylisophthalic acid, tetrachlorophthalic acid, chlorophthalic acid, nitrophthalic acid, p-phenylene diacetic acid, 2,6-naphthalene dicarboxylic acid, 4,4′-biphenyldicarboxylic acid, and anthracene dicarboxylic acid. The lower alkyl esters and acid anhydrides of these may also be used. The dicarboxylic acid component may be used alone or in a mixture of two or more components.

In addition, trivalent or more polyvalent carboxylic acids such as trimellitic acid and pyromellitic acid, and anhydrides or alkyl esters of the above carboxylic acid compounds with carbon numbers of 1 to 3 may also be used.

Examples of the diol component includes saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, and neopentylglycol; unsaturated aliphatic diols such as 2-butene-1,4-diol, 3-butene-1,4-diol, 2-butyne-1,4-diol, 3-butyne-1,4-diol, and 9-octadecene-7,12-diol; and aromatic diols such as bisphenol A and bisphenol F, and alkylene oxide adducts of bisphenols such as ethylene oxide adducts and propylene oxide adducts thereof, and derivatives thereof may also be used. The diol component may be used alone or in a mixture of two or more diol components.

The method for producing the polyester resin is not particularly limited and may be produced by polycondensing (esterifying) the above polyvalent carboxylic acid component and the polyhydric alcohol component using a known esterification catalyst.

Catalysts usable in the production of polyester resins include compounds of alkali metals such as sodium and lithium; compounds comprising Group 2 elements such as magnesium and calcium; compounds of metals such as aluminum, zinc, manganese, antimony, titanium, tin, zirconium, and germanium; phosphorous acid compounds; phosphoric acid compounds; and amine compounds. Specifically, tin compounds including dibutyltin oxide, tin ocrylate, tin dioctylate, and salts thereof may be cited.

Examples of the titanium compound include titanium alkoxides such as tetranormalbutyl titanate (Ti(O-n-Bu)₄), tetraisopropyl titanate, tetramethyl titanate, and tetrastearyl titanate; titanium acylates such as polyhydroxytitanium stearate; titanium chelates such as titanium tetraacetylacetonate, titanium lactate, and titanium triethanolaminate.

Examples of the germanium compound include germanium dioxide. Further, examples of the aluminum compound include polyaluminium hydroxide, aluminum alkoxide, and tributyl aluminate. These may be used alone or in combination of 2 or more thereof.

The polymerization temperature is not particularly limited, but is preferably within a range of 70 to 250° C. Further, the polymerization time is not particularly limited, but is preferably 0.5 to 10 hours. During polymerization, the inside of the reaction system may be reduced in pressure if necessary.

The above polyester resin may be a hybrid crystalline polyester resin having a graft copolymer structure composed of a polyester polymer segment (also referred to as a “polyester resin segment”) and a vinyl polymer segment (also referred to as a “styrene-acrylic polymer segment” or an “amorphous resin segment”). Since the hybrid crystalline polyester resin has a segment of the vinyl resin which is the main component of the binder resin, the hybrid crystalline polyester resin is partially compatible with the polymer according to the present invention and is finely dispersed in the toner. As a result, excellent low temperature fixability may be obtained.

The composition ratio of the polyester polymer segment and the vinyl polymer segment in the hybrid crystalline polyester resin is preferably in the range of 85 to 95% by mass for the polyester polymer segment and 5 to 15% by mass for the vinyl polymer segment. It is more preferred that the polyester polymer segment is in the range of 90 to 95% by mass and the vinyl polymer segment is in the range of 5 to 10% by mass.

The synthetic methods of the above hybrid crystalline polyester resin include, for example, (a), (b), and (c) below.

(a) A method in which a bireactive monomer is reacted with a crystalline polyester polymer segment prepared in advance, thereafter, a vinyl monomer, which is a raw material of a vinyl resin, is reacted to chemically bond the vinyl polymer segment to the crystalline polyester polymer segment.
(b) A method in which a bireactive monomer is reacted with a vinyl resin prepared in advance, thereafter, a polyvalent carboxylic acid monomer and a polyhydric alcohol monomer, which are the raw materials of the crystalline polyester resin, are reacted, and the crystalline polyester polymer segment is chemically bonded to the vinyl polymer segment.
(c) A method in which a crystalline polyester resin and a vinyl resin prepared in advance are reacted with a bireactive monomer respectively, and each resin is chemically bonded to form the crystalline polyester polymer segment and the vinyl polymer segment.

The bireactive monomer is a monomer that combines the crystalline polyester resin and the vinyl resin. It is a monomer having a substituent such as a hydroxy group, a carboxy group, an epoxy group, a primary amino group, or a secondary amino group in the molecule that may react with a crystalline polyester resin, and an ethylenically unsaturated group that may react with an amorphous resin. Among them, a vinyl carboxylic acid having a hydroxy group or a carboxy group, and an ethylenically unsaturated group is preferred. Examples of the usable bireactive monomer include (meth)acrylic acid, fumaric acid, and maleic acid, and hydroxyalkyl (1 to 3 carbon atoms) esters thereof may be used. From the viewpoint of reactivity, acrylic acid, methacrylic acid or fumaric acid is preferred.

From the viewpoint of improving the low temperature fixability, the hot offset resistance and the durability of the toner, it is preferable that the amount of the bireactive monomer used is in the range of 1 to 10 parts by mass to the total amount of the monomer used for forming the vinyl polymer segment. It is more preferred that the amount of the bireactive monomer is in the range of 4 to 8 parts by mass.

From the viewpoint of interaction with the polymer according to the present invention, a crystalline polyester is preferred as the polyester resin, and the carbon atom number of the straight-chain hydrocarbon structure of the aliphatic carboxylic acid is preferably 6 to 16, with 10 to 14 is more preferred. The hydrocarbon structure of the aliphatic carboxylic acid may be partially branched. In this case, the hydrocarbon chain sandwiched between two carboxy groups is identified as the straight-chain hydrocarbon structure. The carbon atom number of the straight-chain hydrocarbon structure of the aliphatic diol is preferably 2 to 12, and particularly 4 to 6 is more preferred. The hydrocarbon structure of the aliphatic diol may be partially branched. In this case, the hydrocarbon chain sandwiched between two alcohol-derived oxygen atoms is identified as the straight-chain hydrocarbon structure.

The content ratio of the polyester resin is preferably in the range of 5 to 30% by mass, with the total mass of the binder resin as 100% by mass, from the viewpoint of a ratio that may achieve both fixability and charge retention. It is more preferably in the range of 5 to 20% by mass

### <Mold Release Agent>

The toner matrix particles according to the present invention include a mold release agent, and the mold release agent contains a fatty acid ester and/or a hydrocarbon wax.

Examples of the fatty acid ester contained in the mold release agent include behenyl behenate, stearyl stearate, behenyl stearate, stearyl behenate, butyl stearate, propyl oleate, hexadecyl palmitate, methyl lignocerate, glycerin monostearate, diglyceryl distearate, pentaerythritol tetrabehenate, diethylene glycol monostearate, dipropylene glycol distearate, sorbitan monostearate, cholesteryl stearate, trimethyl propantribehenate, pentaerythritol diacetate dibehenate, glycerin tribehenate, tristearyl trimellitate, distearyl maleate, and methyl triacontanate. These fatty acid esters may be used alone or in combination of 2 or more thereof. Further, as these fatty acid esters, commercially available products may be used or synthetic products may be used.

Examples of the hydrocarbon wax include polyolefin waxes such as low molecular weight polyethylene and low molecular weight polypropylene, branched hydrocarbon waxes such as microcrystalline wax, long chain hydrocarbon waxes such as a paraffin wax and Sasol wax, dialkyl ketone-based waxes such as distearyl ketone, and fatty acid amide waxes such as ethylenediamine behenylamide and trimellitic acid tristearylamide.

From the viewpoint of a balance of fixability and offset resistance, the content ratio of the mold release agent is preferably in a range of 1 to 25% by mass, and more preferably within a range of 5 to 20% by mass, assuming that the total mass of the polymer according to the present invention is 100% by mass

The toner matrix particles used in the present invention may contain a colorant and a charge control agent as required.

### <Colorant>

The toner matrix particles according to the present invention may contain a colorant. As a colorant, commonly known dyes and pigments may be used.

Examples of the colorant to obtain a black toner include carbon black, a magnetic material, and iron-titanium complex oxide black. Examples of the carbon black that may be used include channel black, furnace black, acetylene black, thermal black, and lamp black. Examples of the magnetic material that may be used include ferrite and magnetite.

Examples of the colorant to obtain a yellow toner include dyes such as C.I. Solvent Yellow 19, 44, 77, 79, 81, 82, 93, 98, 103, 104, 112, and 162; and pigments such as C.I. Pigment Yellows 14, 17, 74, 93, 94, 138, 155, 180, and 185.

Examples of the colorant to obtain a magenta toner include dyes such as C.I. Solvent Red 1, 49, 52, 58, 63, 111, and 122; and pigments such as C.I. Pigment Red 5, 48:1, 53:1, 57:1, 122, 139, 144, 149, 166, 177, 178, and 222.

Examples of the colorant to obtain a cyan toner include dyes such as C.I. Solvent Blue 25, 36, 60, 70, 93, and 95; and pigments such as C.I. Pigment Blue 1, 7, 15, 60, 62, 66, and 76.

The colorant for obtaining the toner of each color may be used alone or a combination of 2 or more kinds for each color. The content ratio of the colorant is preferably in the range of 0.5 to 20% by mass, and more preferably in the range of 2 to 10% by mass with the total mass of the toner matrix particles being 100% by mass

### <Charge Control Agent>

The toner matrix particles according to the present invention may contain a charge control agent. The charge control agent to be used is a substance capable of imparting a positive or negative charge by friction charging and is not particularly limited as long as it is colorless, and various known positive charge control agents and negative charge control agents may be used.

Specific examples of the positively chargeable charge control agent include a nigrosine-based dye such as “Nigrosine Base EX” (manufactured by Orient Chemical Industries Ltd.), a quaternary ammonium salt such as “Quaternary ammonium salt P-51” (manufactured by Orient Chemical Industries Ltd.), “Copy Charge PX VP435” (manufactured by Hoechst Japan Ltd.), an alkoxylated amine, an alkylamide, a molybdate chelating pigment, and an imidazole compound such as “PLZ1001” (manufactured by Shikoku Chemicals Corporation).

Examples of the negatively charged charge control agent include metal complexes such as “BONTRON™ S-22”, “ BONTRON™ S-34”, “BONTRON™ E-81”, “ BONTRON™ E-84” (manufactured by Orient Chemical Industries Ltd.), “Spiron Black TRH” (manufactured by Hodogaya Chemical Co., Ltd.), thioindigo pigments, quaternary ammonium salts such as “Copy Charge NX VP434” (manufactured by Hoechst Japan Ltd.), calixarene compounds such as “BONTRON™ E-89” (manufactured by Orient Chemical Industries Ltd.), boron compounds such as “LR₁₄₇” (manufactured by Japan Carlit Co., Ltd.), and fluorine compounds such as magnesium fluoride.

As the metal complexes used as negatively charging charge control agents, compounds having various structures such as metal oxycarboxylate complexes, metal dicathoxylate complexes, metal amino acid complexes, diketone metal complexes, diamine metal complexes, azo group-containing benzene-benzene derivative skeleton metal complexes, and azo group-containing benzene-naphthalene derivative skeleton metal complexes may be used. The charging property of the toner is improved by configuring the toner matrix particle to contain the charge control agent in this manner.

The content ratio of the charge control agent is preferably in the range of 0.01 to 30% by mass, and more preferably in the range of 0.1 to 10% by mass in the toner matrix particles.

The form of the toner matrix particles according to the present invention is not particularly limited, and for example, a so-called single-layer structure (a homogeneous structure other than a core-shell type), a core-shell structure, a multilayer structure of three or more layers, or a domain-matrix structure may be used.

### <External Additive>

In order to improve fluidity, charging property, and cleaning property of the toner, an external additive such as fluidity increasing agent and cleaning assisting agent may be added as an after treatment agent to constitute the toner according to the present invention.

Examples of the external additive include inorganic oxide particles such as silica particles, alumina particles, and titanium oxide particles; inorganic stearic acid compound particles such as aluminum stearate particles and zinc stearate particles; and inorganic particles of inorganic titanium acid compound particles such as strontium titanate particles and zinc titanate particles. These may be used alone, or they may be used in combination of two or more kinds From the viewpoint of improving heat-resisting storage stability and environmental stability, these inorganic particles may be subjected to a surface treatment by using a silane coupling agent, a titanium coupling agent, a higher aliphatic acid, or a silicone oil.

The addition amount of the external additive is preferably in the range of 0.05 to 5 parts by mass, more preferably in the range of 0.1 to 3 parts by mass, with respect to 100 parts by mass of the toner matrix particles.

### <Average Particle Size of Toner Particles>

It is preferable that the toner particles of the present invention have an average particle size of 4 to 10 μm, more preferably 5 to 9 μm in volume-based median diameter (D₅₀). When the volume-based median diameter (D₅₀) is within the above-described range, the transfer efficiency is improved, the image quality of halftone is improved, and the image quality of fine lines and dots is improved.

In the present invention, the volume-based median diameter (D₅₀) of the toner particles is measured and calculated by using measuring equipment composed of a “COULTER COUNTER 3” (manufactured by Beckman Coulter, Inc.) and a computer system installed with data processing software “Software V3.51” (manufactured by Beckman Coulter, Inc.) connected thereto.

Specifically, 0.02 g of sample to be measured (the toner particles) is blended in 20 mL of the surfactant solution (for the purpose of dispersing toner particles, for example, a surfactant solution in which a neutral detergent including a surfactant component is diluted by 10 times with pure water), ultrasonic dispersion is performed for 1 minute and a toner particle dispersion liquid is prepared. This toner particle dispersion liquid is poured into a beaker including ISOTON II (manufactured by Beckman Coulter, Inc.) in the sample stand with a pipette until the indicated concentration on the measuring apparatus reaches 8%. Here, by setting this content range, it is possible to obtain a reproducible measurement value. Then, the liquid is measured by setting the counter of the particles to be measured to 25,000. The aperture diameter is set to be 50 μm. The frequency count is calculated by dividing the range of the measurement range 1 to 30 μm by 256. The particle size where the accumulated volume counted from the largest size reaches 50% is determined as the volume-based median diameter (D₅₀).

### [Production Method of Toner]

The production method of the toner of the present invention is a method for producing an electrostatic charge image developing toner including toner matrix particles containing a binder resin and a colorant. It is characterized by having at least a step of preparing a resin particle dispersion liquid containing a polymer obtained by copolymerizing a first polymerizable monomer having a structure represented by the following Formula (2). That is, the first polymerizable monomer having the structure represented by the following Formula (2) is polymerized, and the polymer having the first structural unit represented by Formula (1) is synthesized. It has a step of preparing a resin particle dispersion liquid containing this polymer.

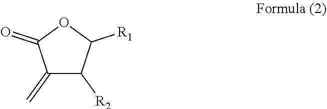

In Formula (2), R₁ and R₂ each independently represent a hydrogen atom or an alkyl group having 1 to 4 carbon atoms.

The method for producing the toner of the present invention may include a step of preparing a resin particle dispersion liquid containing the polymer according to the present invention, and others are not particularly limited. For example, the polymer according to the present invention, a mold release agent, and a colorant are melt-kneaded, and then pulverized and classified to obtain a toner. Further, a toner may be obtained by an emulsion aggregation method in which polymer particles are prepared with a polymerizable monomer by emulsion polymerization or miniemulsion polymerization in an aqueous medium, and dispersed particles of the polymer particles, the mold release agent particles, and, if necessary, colorant particles are aggregated and fused. As for the emulsion aggregation method, a method described in JP-A 5-265252, JP-A 6-329947, and JP-A 9-15904 may be employed. Further, it may be a production method using the suspension polymerization method described in JP-A 2010-191043.

Among them, from the viewpoint that the particle diameter and the shape are easily controlled and the energy cost at the time of production may be reduced, it is preferable to use a production method using an emulsion aggregation method.

The production method using such emulsion aggregation method may include the following steps.

(1A) Resin particle dispersion liquid preparation step of preparing a dispersion liquid of resin particles containing the polymer according to the present invention
(1B) Polyester particle dispersion liquid preparation step of preparing a dispersion liquid of polyester particles
(1C) Colorant particle dispersion liquid preparation step of preparing a dispersion liquid of colorant particles
(1D) Mold release agent particle dispersion liquid preparation step of preparing a dispersion liquid of mold release agent particles
(2) Association step of adding an aggregating agent to an aqueous medium in which the resin particles containing the polymer according to the present invention, the colorant particles and the mold release agent particles are present, and simultaneously performing aggregation and fusion while proceeding salting out, thereby forming associated particles
(3) Ripening step of forming toner particles by controlling the shape of the associated particles
(4) Filtration-washing step of filtering out toner particles from an aqueous medium and removing a surfactant from the toner particles
(5) Drying step of drying the washed toner particles
(6) External additive addition step of adding an external additive to the dried toner particles.

It is preferable to include each step described above. Hereinafter, the steps (1A) to (1D) will be described.

### (1A) Resin Particle Dispersion Liquid Preparation Step of Preparing a Dispersion Liquid of Resin Particles Containing the Polymer According to the Present Invention

In this step, resin particles are formed by a conventionally known emulsion polymerization method. As an example, the polymerizable monomers (the first polymerizable monomer and the second polymerizable monomer) constituting the binder resin is fed into an aqueous medium, dispersed, and these polymerizable monomers are polymerized by a polymerization initiator to prepare a dispersion liquid of the resin particles containing a polymer according to the present invention.

In addition to the method of polymerizing a polymerizable monomer with a polymerization initiator in an aqueous medium as described above, other methods of obtaining the resin particle dispersion liquid include, for example, a method of performing dispersion processing in an aqueous medium without using a solvent, or a method of dissolving a polymer in an organic solvent such as ethyl acetate to make a solution and then emulsifying and dispersing the solution in an aqueous medium using a dispersion machine, then, solvent removing treatment is performed. At this time, if necessary, the resin may contain a mold release agent in advance. It is also preferred to polymerize the resin in the presence of appropriately known surfactants (for example, an anionic surfactant such as sodium polyoxyethylene (2) dodecyl ether sulfate, sodium dodecyl sulfate, and sodium dodecyl benzene sulfonate) for dispersion.

The volume-based median diameter of the resin particles in the dispersion liquid is preferably in the range of 50 to 300 nm. The volume-based median diameter of the resin particles in the dispersion liquid may be measured by a dynamic light scattering method using “MICROTRAC UPA-150” (manufactured by Nikkiso Co., Ltd.).

### (1B) Polyester Particle Dispersion Liquid Preparation Step

In this step, polyester particle dispersion liquid is formed by a conventionally known method. As an example, a method of dissolving a polyester resin in a solvent such as methyl ethyl ketone, emulsifying and dispersing this solution in an aqueous medium with a disperser, and then performing a solvent removal treatment may be mentioned. For dispersion, it is preferable to disperse in the presence of a known surfactant (for example, anionic surfactants such as sodium polyoxyethylene (2) dodecyl ether sulfate, sodium dodecyl sulfate, and sodium dodecyl benzene sulfonate). From the viewpoint of particle size control, sodium hydroxide solution may also be added.

The volume-based median diameter of the resin particles in the dispersion liquid is preferably in the range of 50 to 300 nm. The volume-based median diameter of the resin particles in the dispersion liquid may be measured by a dynamic light scattering method using “MICROTRAC UPA-150” (manufactured by Nikkiso Co., Ltd.).

### (1C) Colorant Particle Dispersion Liquid Preparation Step

This preparing step of the colorant particle dispersion liquid is a step of preparing a dispersion liquid of colorant particles by dispersing the colorant in the form of fine particles in an aqueous medium. The colorant may be dispersed using mechanical energy. The volume-based median diameter of the colorant particles in the dispersion liquid is preferably in the range of 10 to 300 nm, and more preferably in the range of 50 to 200 nm. The volume-based median diameter of the colorant particles in the dispersion liquid may also be measured by a dynamic light scattering method using “MICROTRAC UPA-150” (manufactured by Nikkiso Co., Ltd.) as described above.

### (1D) Mold Release Agent Particle Dispersion Liquid Preparation Step

This mold release agent particle dispersion liquid preparation step is a step of preparing a dispersion liquid of the mold release agent particles. Dispersion of the mold release agent may be performed using mechanical energy. The volume-based median diameter of the mold release agent particles in the dispersion liquid is preferably in the range of 100 to 1000 nm, and more preferably in the range of 200 to 700 nm. The volume-based median diameter of the mold release agent particles in the dispersion liquid may be measured by, for example, a laser diffraction particle size analyzer “LA-750” (manufactured by Horiba Ltd.).

### (Aqueous Medium)

Examples of the aqueous medium used in the steps of (1A) to (1D) include an aqueous medium composed of water as a main component (50% by mass or more), and a water-soluble solvent such as alcohols or glycols, and an optional component such as a surfactant or a dispersant. As the aqueous medium, preferably, a mixture of water and a surfactant is used.

Examples of the water-soluble solvent described above include methanol, ethanol, isopropanol, butanol, acetone, methyl ethyl ketone, and tetrahydrofuran. Of these, alcohols such as methanol, ethanol, isopropanol, and butanol which are organic solvents that do not dissolve the polymer are preferable.

The surfactant may be a cationic surfactant, an anionic surfactant, or a nonionic surfactant. Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactant include fatty acid soaps such as sodium stearate and sodium dodecanoate, sodium dodecylbenzenesulfonate, and sodium dodecyl sulfate. Examples of the nonionic surfactant include polyoxyethylene dodecyl ether, polyoxyethylene hexadecyl ether, polyoxyethylene nonyl phenyl ether, polyoxyethylene dodecyl ether, polyoxyethylene sorbitan monooleate ether, and monodecanoyl sucrose.

These surfactants may be used alone or in combination of two or more. Among them, preferably an anionic surfactant, more preferably sodium dodecylbenzenesulfonate is used. The addition amount of the surfactant is preferably in the range of 0.01 to 10 parts by mass, more preferably in the range of 0.04 to 2 parts by mass with respect to 100 parts by mass of the aqueous medium.

The steps from (2) Association step to (6) External additive addition step may be performed according to various conventionally known methods. The aggregating agent used in (2) Association step is not particularly limited, but materials selected from metal salts are suitably used.

Examples of the metal salt include: monovalent metal salts of alkali metal salts such as sodium, potassium and lithium; divalent metal salts such as calcium, magnesium, manganese and copper; and trivalent metal salts such as iron and aluminum. Specifically, examples of the metal salt include sodium chloride, potassium chloride, lithium chloride, calcium chloride, magnesium chloride, zinc chloride, copper sulfate, magnesium sulfate, manganese sulfate, and polyaluminum chloride. Among them, a divalent or trivalent metal salt is particularly preferable because aggregation may be promoted with a smaller amount. These may be used alone or in combination of two or more.

### [Developer]

The toner of the present invention may be used, for example, as a one-component magnetic toner containing a magnetic material, as a two-component developer mixed with a so-called carrier, or as a non-magnetic toner used alone. Any of these may be suitably used.

Examples of the magnetic material contained in the one-component developer include magnetite, γ-hematite, and various ferrites. As the carrier constituting the two-component developer, magnetic particles made of conventionally known materials such as metals of iron, steel, nickel, cobalt, ferrite, and magnetite, and alloys of these metals with metals such as aluminum and lead may be used. The carrier particles are preferably coated carrier particles obtained by coating the surfaces of magnetic particles with a coating agent such as a resin, or resin-dispersed carrier particles in which magnetic powder is dispersed in a binder resin.

Although the coating resin is not limited, examples of the coating resin include an olefin resin, an acrylic resin, a styrene resin, styrene-acrylic resin, a silicone resin, a polyester resin, or a fluorine resin. Although the resin constituting the resin-dispersed carrier particles is not limited, any known resins may be used. Examples of the resin constituting the resin-dispersed carrier particles include an acrylic resin, a styrene-acrylic resin, a polyester resin, a fluororesin, and a phenol resin.

The volume-based median diameter of the carrier particles is preferably in the range of 20 to 100 μm, and more preferably in the range of 25 to 60 μm. The volume-based median diameter of the carrier particles may be typically measured by a laser diffraction particle size distribution measuring apparatus “HELOS” (manufactured by SYMPATEC Co., Ltd.) equipped with a wet disperser.

The mixing amount of the toner with respect to the carrier is preferably in the range of 2 to 10% by mass, assuming that the total mass of the toner and the carrier is 100% by mass.

### [Image Forming Method]

The toner of the present invention may be suitably used for an image forming method including a fixing step by a thermal pressure fixing method capable of applying pressure and heating. In particular, the present invention may be suitably used for an image forming method in which the fixing temperature in the fixing step is set at a relatively low fixing temperature which is a temperature in the range of 80 to 110° C., preferably 80 to 95° C., at the surface temperature of the heating member in the fixing nip portion. Further, it may be suitably used for a high-speed fixing image forming method in which the fixing linear velocity is in the range of 200 to 600 mm/sec.

In this image forming method, specifically, the toner of the present invention as described above is used, for example, to develop an electrostatic charge image formed on a photoreceptor to obtain a toner image, and this toner image is transferred to an image support. Thereafter, the toner image transferred onto the image support is fixed to the image support by a fixing process of a thermal pressure fixing method, whereby a printed material on which a visible image is formed is obtained.

The toner of the present invention may be used in a monochrome image forming method or a full-color image forming method. The full-color image forming method may be applied to any image forming method, such as a four-cycle image forming method composed of four types of color developing apparatuses relating to yellow, magenta, cyan, and black, and one photoreceptor, or a tandem image forming method in which an image forming unit having a color developing apparatus relating to each color and a photoreceptor is mounted for each color.

### EXAMPLES

Hereinafter, the present invention will be specifically described with reference to Examples, but the present invention is not limited thereto. In the following examples, unless otherwise specified, the operation was carried out at room temperature (25° C.). Also, unless otherwise specified, “% ” and “parts” mean “% by mass” and “parts by mass”, respectively.

The peak molecular weight of the polymer in the resin particle dispersion liquid was measured as follows. The measurement results are shown in Table I below.

The instrument “HLC-8220” (Tosoh Corporation) and the column “TSKguardcolumn and columns TSKgel SuperHZM-M Triple” (Tosoh Corporation) were used, and tetrahydrofuran (THF) was flowed through the column at a flow rate of 0.2 ml/min. The sample was dissolved at room temperature (25° C.) using an ultrasonic dispersion machine for 5 minutes to obtain a concentration of 1 mg/ml. The sample solution was then processed through a membrane filter with a pore size of 0.2 gm to obtain a sample solution, and 10 μL of this sample solution was injected into the apparatus together with the above-mentioned carrier solvent and detected using a refractive index detector (RI detector), and the molecular weight distribution of the sample was determined from the molecular weight distribution of the sample.

<Preparation of Resin Particle Dispersion Liquid 1>

A 5-L stainless steel vessel (SUS vessel) equipped with a stirrer, a temperature sensor, a cooling pipe, and a nitrogen induction device was charged with a surfactant solution containing 8 parts by mass of sodium dodecyl dissolved in 3,000 parts by mass of ion-exchanged water. The temperature of the solution was raised to 80° C. while stirring at a stirring speed of 230 rpm under a nitrogen flow.

To this surfactant solution was added an initiator solution containing 10 parts by mass of potassium persulfate dissolved in 200 parts by mass of ion-exchanged water. After setting the temperature to 80° C., the following monomer mixture was added dropwise over a period of 100 minutes, and the system was heated and stirred at 80° C. for 2 hours to polymerize the monomers. Thus, a resin particle dispersion liquid 1 was prepared.

### [Monomer Mixture]

Example compound M1: 250.0 parts by mass

Styrene (St): 253.0 parts by mass

n-Butyl acrylate (nBA): 258.0 parts by mass

Methacrylic acid (MAA): 44.0 parts by mass

n-Octyl-3-mercaptopropionate: 5.5 parts by mass

The volume-based median diameter of the binder resin particles in the obtained binder resin particle dispersion liquid 1 was measured by a dynamic light scattering method using “MICROTRAC UPA-1 50” (manufactured by Nikkiso Co., Ltd.), and the obtained diameter was 128 nm.

### <Preparation of Resin Particle Dispersion Liquids 2 to 9>

In the preparation of the above-mentioned resin particle dispersion liquid 1, resin particle dispersion liquids 2 to 9 each were prepared in the same manner except that the combination and addition amount of the monomer were changed as described in Table I below.

In Table I below, St stands for styrene, MMA stands for methyl methacrylate, nBA stands for n-butyl acrylate, iBA stands for iso-butyl acrylate, 2EHA stands for 2-ethylhexyl acrylate, MAA stands for methacrylic acid, and AA stands for acrylic acid.

TABLE I

| Resin | First polymerizable monomer having | | | | | | | | |
|---|---|---|---|---|---|---|---|---|---|
| particle | a structure represented by Formula (2) | | Second polymerizable monomer Added | | | | | | Peak |
| dispersion | Example | Added amount | amount [parts by mass] | | | | | | molecular |
| liquid No. | compound | [parts by mass] | St | MMA | nBA | 2EHA | MAA | AA | weight |
| 1 | M1 | 250.0 | 253.0 | 0.0 | 258.0 | 0.0 | 44.0 | 0.0 | 19800 |
| 2 | M2 | 234.0 | 201.0 | 0.0 | 326.0 | 0.0 | 44.0 | 0.0 | 21300 |
| 3 | M3 | 242.0 | 213.0 | 81.0 | 0.0 | 241.0 | 00 | 28.0 | 21900 |
| 4 | M4 | 242.0 | 246.0 | 0.0 | 192.0 | 85.0 | 40.0 | 0.0 | 21050 |
| 5 | M5 | 282.0 | 189.0 | 0.0 | 213.0 | 81.0 | 40.0 | 0.0 | 21600 |
| 6 | M6 | 242.0 | 266.0 | 0.0 | 269.0 | 0.0 | 00 | 28.0 | 21950 |
| 7 | M7 | 234.0 | 225.0 | 0.0 | 242.0 | 64.0 | 40.0 | 0.0 | 21500 |
| 8 | M8 | 238.0 | 193.0 | 80.0 | 97.0 | 157.0 | 40.0 | 0.0 | 21500 |
| 9 | — | 0.0 | 551.0 | 0.0 | 210.0 | 0.0 | 44.0 | 0.0 | 21050 |

### <Preparation of Polyester Particle Dispersion Liquid 1>

### (Synthesis of Crystalline Polyester Resin 1)

The raw monomers and the polymerization initiator of the following amorphous resin segment (styrene-acrylic resin) were placed in a dropping funnel.

Styrene: 21.7 parts by mass

n-Butyl acrylate: 8.0 parts by mass

Acrylic acid: 1.8 parts by mass

Polymerization initiator (di-t-butyl peroxide): 4.0 parts by mass

Meanwhile, the raw monomers of the following crystalline polyester resin segment (crystalline polyester resin) were placed in a four-necked flask equipped with a nitrogen inlet tube, a dehydration tube, a stirrer and a thermocouple, and heated to 170° C. to dissolve them.

Tetradecanedioic acid: 440 parts by mass

Butanediol: 135 parts by mass

Then, while stirring, the raw monomers for the amorphous resin segment were dropped from the dropping funnel over a period of 90 minutes, and ripened for 60 minutes. After that, the unreacted monomers of addition polymerization were removed under reduced pressure (8 kPa). The amount of monomer removed at this time was very small compared to the amount of raw monomer added. Then, 0.8 g of Ti(OBu)₄ was added as an esterification catalyst. The temperature was raised to 235° C., and the reaction was continued under normal pressure for 5 hours and then under reduced pressure (8 kPa) for 1 hour. Next, after cooling to 200° C., the reaction was carried out under reduced pressure (20 kPa) for 1 hour to obtain a crystalline polyester resin (hybrid crystalline polyester resin) 1.

(Preparation of Polyester Particle Dispersion Liquid 1) 82 parts by mass of the hybrid crystalline polyester resin 1 obtained as described above was added to 82 parts by mass of methyl ethyl ketone, and the mixture was stirred at 7.0° C. for 30 minutes to dissolve. Next, 2.5 parts by mass of 25% by mass of sodium hydroxide aqueous solution was added to this dissolved solution. This dissolved solution was placed in a reaction vessel having a stirrer, and while stirring, 236 parts by mass of water warmed to 70° C. was mixed dropwise for 70 minutes. During the dropwise mixing, the liquid in the vessel became cloudy, and after dropping the entire amount, a uniformly emulsified state was obtained. The particle diameter of oil droplets in the emulsion was measured with a laser diffraction particle size analyzer “LA-750” (manufactured by HORIBA Ltd.). As a result, the volume average particle diameter was 124 nm.

Then, the emulsion was kept at 70° C. and stirred for 3 hours under reduced pressure of 15 kPa using a diaphragm vacuum pump “V-700” (manufactured by BUCHI Corporation) to remove methyl ethyl ketone by distillation. A crystalline polyester particle dispersion liquid 1 (25% by mass of solid content) in which fine particles of crystalline polyester resin 1 were dispersed was prepared. As a result of measurement using the above particle size distribution analyzer, the volume average particle diameter of the crystalline polyester particles in the crystalline polyester particle dispersion liquid 1 was 200 nm.

### <Preparation of Polyester Particle Dispersion Liquids 2 and 3>

Polyester particle dispersion liquids 2 and 3 were prepared in the same manner as the preparation of polyester particle dispersion liquid 1, except that the monomer amounts were changed to those listed in Table II below to synthesize a crystalline polyester resin.

TABLE II

| Polyester | Styrene-acrylic modified crystalline polyester resin composition ratio | | | | | |
|---|---|---|---|---|---|---|
| particle | Crystalline polyester | | | Amorphous resin (StAc) | | |
| dispersion | resin segment | Monomer species | | segment | Monomer species | |
| liquid No. | [% by mass] | [parts by mass] | | [% by mass] | [parts by mass] | |
| 1 | 95 | Tetradecanedioic | 440 | 5 | Styrene | 21.7 |
| | | acid | | | n-Butyl acrylate | 8.0 |
| | | Butanediol | 135 | | Acrylic acid | 1.8 |
| 2 | 90 | Tetradecanedioic | 416 | 10 | Styrene | 43.4 |
| | | acid | | | n-Butyl acrylate | 16.0 |
| | | Butanediol | 128 | | Acrylic acid | 3.6 |
| 3 | 100 | Tetradecanedioic | 464 | 0 | Styrene | 0.0 |
| | | acid | | | n-Butyl acrylate | 0.0 |
| | | Butanediol | 142 | | Acrylic acid | 0.0 |

### <Preparation of Colorant Particle Dispersion Liquid 1>

Colorant: Carbon black (Mogul™ L, manufactured by Cabot Corporation): 10 parts by mass

Anionic surfactant (20% aqueous solution of sodium dodecylbenzenesulfonate): 1.5 parts by mass

Ion-exchanged water: 90 parts by mass

The above components were mixed and dispersed in a SC mill to obtain a colorant particle dispersion liquid 1. The volume-based median diameter of the colorant particles in the dispersion liquid was measured by a dynamic light scattering method using “MICROTRAC UPA-150” (manufactured by Nikkiso Co. Ltd.). It was found to be 155 nm.

### <Preparation of Mold Release Agent Particle Dispersion Liquid 1>

Behenyl behenate: 100 parts by mass

Sodium dodecyl sulfate: 5 parts by mass

Ion-exchanged water: 240 parts by mass

The above components were dispersed in a round stainless steel flask using a homogenizer “ULTR-TURRAX™ T50” (manufactured by IKA Co.) for 10 minutes, and then dispersed in a pressure discharge homogenizer to obtain a release agent particle dispersion liquid 1. The volume-based median diameter of the release agent particles in the dispersion was measured by a laser diffraction particle size analyzer “LA-750” (manufactured by HORIBA, Ltd.). It was found to be 530 nm.

### [Production of Toner 1]

### <Preparation of Toner Matrix Particle Dispersion Liquid 1>

Into a reaction vessel equipped with a stirrer, a temperature sensor and a cooling tube, 346 parts by mass (in terms of solid content) of the resin particle dispersion liquid 1, 8 parts by mass of the colorant particle dispersion liquid 1, and 43.25 parts by mass of the release agent particle dispersion liquid 1, and 2000 parts by mass of ion-exchanged water were added. Under room temperature, the pH was adjusted to 10 by adding 5 mol/L sodium hydroxide aqueous solution.

Furthermore, a solution of 60 parts by mass of magnesium chloride dissolved in 60 parts by mass of ion-exchanged water was added at 30° C. for 10 minutes under stirring. After allowing the solution to stand for 3 minutes, the temperature was increased to 80° C. over a period of 60 minutes. After reaching 80° C., 43.25 parts by mass (in terms of solid content) of the polyester particle dispersion liquid 1 was added over a period of 20 minutes. The stirring speed was adjusted so that the particle diameter growth rate would be 0.01 μm/min. The particle diameter was grown until the volume-based median diameter measured by Coulter Multisizer 3 (manufactured by Coulter Beckman) was 6.0 μm.

Thereafter, an aqueous solution of 190 parts by mass of sodium chloride dissolved in 760 parts by mass of ion-exchanged water was added to stop the growth of the particles. Next, the temperature was increased and stirred at 80° C. to progress the fusion of the particles until the average circularity of the toner particles became 0.970. Then, it was cooled, and the liquid temperature was lowered to 30° C. or less to obtain a toner matrix particle dispersion liquid 1.

### <Washing and Drying Step>

The toner matrix particle dispersion liquid 1 was separated into solid and liquid in a basket type centrifuge “MARK III Model No. 60×40” (manufactured by Matsumoto Machine Sales Co., Ltd.) to form a wet cake of toner matrix particles. The wet cake was washed with ion-exchanged water at 45° C. in the above basket-type centrifuge until the electric conductivity of the filtrate became 5 μS/cm. The wet cake was then transferred to “Flash Jet Myer” (manufactured by Seishin Enterprise Co., Ltd.) and dried until the moisture content became 0.5% by mass to obtain toner matrix particles.

### <External Additive Treatment of Toner Matrix Particles>

To 100 parts by mass of the toner matrix particles obtained above, 1 part by mass of hydrophobic silica (number average primary particle diameter=12 nm) and 0.3 parts by mass of hydrophobic titania (number average primary particle diameter=20 nm) were added, and the mixture was mixed by a Henschel™ mixer to perform an external additive treatment to produce a toner 1.

### [Production of Toners 2 to 18]

Toners 2 to 18 were produced in the same manner as the production of toner 1, except that the toner matrix particles were made using the aforementioned resin particle dispersion liquid and polyester particle dispersion liquid in the combinations described in Table III below. In Table III, the polyester resin ratio represents the content (% by mass) of the polyester resin in the binder resin.

TABLE III

| | | Resin particle dispersion | | Polyester particle dispersion | | |
|---|---|---|---|---|---|---|
| | | liquid | | liquid | | |
| | Toner matrix | | Added amount | | Added amount | |
| | particle | | [parts by mass] | | [parts by mass] | Polyester resin |
| Toner | dispersion liquid | | (in terms of | | (in terms of | ratio |
| No. | No. | No. | solid content) | No. | solid content) | [% by mass] |
| 1 | 1 | 1 | 346 | 1 | 43.25 | 11.1 |
| 2 | 2 | 2 | 346 | — | 0.00 | 0.0 |
| 3 | 3 | 2 | 346 | 1 | 10.75 | 3.0 |
| 4 | 4 | 2 | 346 | 1 | 18.75 | 5.1 |
| 5 | 5 | 2 | 346 | 1 | 43.25 | 11.1 |
| 6 | 6 | 2 | 346 | 1 | 145.25 | 29.6 |
| 7 | 7 | 2 | 346 | 1 | 160.75 | 31.7 |
| 8 | 8 | 2 | 346 | 2 | 43.25 | 11.1 |
| 9 | 9 | 2 | 346 | 3 | 43.25 | 11.1 |
| 10 | 10 | 3 | 346 | 1 | 43.25 | 11.1 |
| 11 | 11 | 4 | 346 | 1 | 43.25 | 11.1 |
| 12 | 12 | 5 | 346 | 1 | 43.25 | 11.1 |
| 13 | 13 | 6 | 346 | 1 | 43.25 | 11.1 |
| 14 | 14 | 7 | 346 | 1 | 43.25 | 11.1 |
| 15 | 15 | 8 | 346 | 1 | 43.25 | 11.1 |
| 16 | 16 | 9 | 346 | — | 0.00 | 0.0 |
| 17 | 17 | 9 | 346 | 1 | 43.25 | 11.1 |
| 18 | 18 | 9 | 346 | 3 | 43.25 | 11.1 |

### [Preparation of Two-Component Developer]

100 parts by mass of ferrite particles (volume-based median diameter: 50 μm (manufactured by Powdertech Co., Ltd.) and 4 parts by mass of methyl methaciylate-cyclohexyl methacrylate copolymer resin (volume-based median diameter: 85 nm of primary particles) were put into a horizontal stirring blade type high-speed stirrer, mixed for 15 minutes under the conditions of peripheral speed of the stirring blade: 8 m/s, temperature: 30° C., and then heated to 120° C. to continue stirring for 4 hours. Thereafter, a resin-coated carrier was produced by cooling and removing debris of methyl methaciylate-cyclohexyl methacrylate copolymer resin using a 200 mesh sieve. The resin-coated carrier was mixed with each of the above-mentioned toners 1 to 18 so that the concentration of the toner with respect to the total mass of the toner and the carrier was 7% by mass to prepare two-component developers 1 to 18.

### [Evaluation]

### (Image Forming Method)

Image evaluation was performed using a modified machine A of a commercially available color MFP “bizhub PRESS™ C600 A” (manufactured by Konica Minolta, Inc.). The modified machine A was made so that the fusing temperature, toner adhesion amount, and system speed could be set freely. This modified machine A was sequentially loaded with the developer prepared as described above and evaluated.

### (1) Low Temperature Fixability (UO)

### (Low Temperature Fixability: Under-Offset)

In a fixing experiment in which a solid image with a toner adhesion of 8 g/m² was fixed in an environment of normal temperature and humidity (temperature 20° C., humidity 50% RH), the temperature of the under fixing roller was set 20° C. lower than that of the upper fixing belt. The temperature of the upper fixing belt was repeatedly changed from 110° C. to 200° C. in increments of 5° C. This experiment was conducted at a fixing speed of 300 mm/sec. Evaluation was performed using A4 size NPI high quality 127.9 g/m² (manufactured by Nippon Paper Industries, Ltd.).

“Under-offset” refers to an image defect in which the toner layer is not sufficiently melted by the given heat when passing through the fixing machine and thus peels off from the transfer material such as recording paper. When an image is formed by the method described above, the lower limit temperature of fixing of the upper fusing belt at which under-offset does not occur is evaluated and used as an index of low temperature fixability. The lower the lower limit temperature for fixing, the better the fixing performance, and the temperature lower than 140° C. was considered to be acceptable.

### (2) Bending Resistance

In a fixing experiment in which a solid image with a toner adhesion of 8 g/m² was fixed in an environment of normal temperature and humidity (temperature 20° C., humidity 50% RH), the temperature of the under fixing roller was set 20° C. lower than that of the upper fixing belt. The temperature of the upper fixing belt was repeatedly changed from 110° C. to 200° C. in increments of 5° C. This experiment was conducted at a fixing speed of 300 mm/sec. Evaluation was performed using A4 size thick paper weighing 350 g/m².

The fixed solid image was folded using a folding machine, air was blown on it at 0.35 MPa. The state of the fold was evaluated on a 5-level scale with reference to the limit samples, and Ranks 3 to 5 were considered acceptable.

### (Evaluation Criteria)

Rank 5: No peeling at all of the folds

Rank 4: There is peeling according to some folds.

Rank 3: There is thin linear peeling according to the folds.

Rank 2: There is thick peeling according to the folds.

Rank 1: There is large peeling in the image.

TABLE IV

| Two- | | Low temperature fixability | | |
|---|---|---|---|---|
| component | | (UO lower limit | Bending | |
| developer | Toner | temperature) | Test | |
| No. | No. | [° C.] | Rank | Remarks |
| 1 | 1 | 129 | 4 | Present |
| | | | | Invention |
| 2 | 2 | 138 | 3 | Present |
| | | | | Invention |
| 3 | 3 | 135 | 4 | Present |
| | | | | Invention |
| 4 | 4 | 132 | 5 | Present |
| | | | | Invention |
| 5 | 5 | 127 | 5 | Present |
| | | | | Invention |
| 6 | 6 | 127 | 5 | Present |
| | | | | Invention |
| 7 | 7 | 125 | 4 | Present |
| | | | | Invention |
| 8 | 8 | 129 | 5 | Present |
| | | | | Invention |
| 9 | 9 | 133 | 3 | Present |
| | | | | Invention |
| 10 | 10 | 131 | 3 | Present |
| | | | | Invention |
| 11 | 11 | 130 | 3 | Present |
| | | | | Invention |
| 12 | 12 | 130 | 4 | Present |
| | | | | Invention |
| 13 | 13 | 131 | 3 | Present |
| | | | | Invention |
| 14 | 14 | 129 | 5 | Present |
| | | | | Invention |
| 15 | 15 | 131 | 3 | Present |
| | | | | Invention |
| 16 | 16 | 140 | 1 | Comparative |
| | | | | Example |
| 17 | 17 | 130 | 2 | Comparative |
| | | | | Example |
| 18 | 18 | 136 | 2 | Comparative |
| | | | | Example |

As is clear from the results shown in Table IV above, it was found that by including the polymer having the first structural unit represented by the above Formula (1), the toners 1 to 15 of the present invention exhibit excellent performance in both low temperature fixability and bending resistance.

On the other hand, the toners 16 to 18 which do not contain the polymer having the first structural unit represented by Formula (1) have good low temperature fixability but poor bending resistance, and it was found to be difficult to achieve both low temperature fixability and bending resistance.

Although the embodiments of the present invention have been described and illustrated in detail, the disclosed embodiments are made for purposes of illustration and example only and not limitation. The scope of the present invention should be interpreted by terms of the appended claims. What is claimed is:

1. An electrostatic charge image developing toner comprising toner matrix particles containing a binder resin and a colorant, wherein the toner matrix particles contain, as the binder resin, at least a polymer having a first structural unit represented by the following Formula (1), 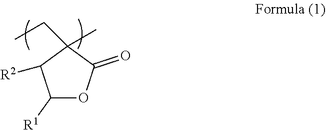
in Formula (1), R₁ and R₂ each independently represent a hydrogen atom or an alkyl group having 1 to 4 carbon atoms.

2. The electrostatic charge image developing toner according to claim 1, wherein R₁ and R₂ in Formula (1) each independently represent a hydrogen atom or a methyl group.

3. The electrostatic charge image developing toner according to claim 1, wherein R₁ in Formula (1) represents a methyl group and R₂ in Formula (1) represents a hydrogen atom.

4. The electrostatic charge image developing toner according to claim 1, wherein the toner matrix particles contain, as the binder resin, a copolymer having the first structural unit and a second structural unit.

5. The electrostatic charge image developing toner according to claim 4, wherein the second structural unit is at least a structural unit derived from one of styrene, acrylic acid, acrylic ester, methacrylic acid, or methacrylic ester.

6. The electrostatic charge image developing toner according to claim 5, wherein the second structural unit is at least one of styrene, n-butyl acrylate, 2-ethylhexyl acrylate, methacrylic acid, or methyl methacrylate.

7. The electrostatic charge image developing toner according to claim 1, wherein the binder resin contains a crystalline polyester resin in an amount of 5 to 30% by mass based on the binder resin.

8. The electrostatic charge image developing toner according to claim 7, wherein the crystalline polyester resin is a hybrid crystalline polyester resin formed by chemical bonding of a polyester polymer segment and a vinyl polymer segment.

9. A method for producing an electrostatic charge image developing toner comprising toner matrix particles containing a binder resin and a colorant, the method comprising a step of preparing a resin particle dispersion liquid containing a polymer obtained by copolymerizing at least a first polymerizable monomer having a structure represented by the following Formula (2), 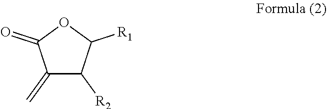
in Formula (2), R₁ and R₂ each independently represent a hydrogen atom or an alkyl group having 1 to 4 carbon atoms.
